(19) United States
(12) Patent Application Publication
(10) Pub. No.: US 2009/0324201 A1
(43) Pub. Date: Dec. 31, 2009

(54) DATA-PROCESSING DEVICE AND DATA PROCESSING METHOD

(76) Inventor: Chiharu SAKAI, Kanagawa (JP)

Correspondence Address: FROMMER LAWRENCE & HAUG, 745 FIFTH AVENUE- 10TH FL., NEW YORK, NY, 10151, US

(21) Appl. No.: 12/489,694

(22) Filed: Jun. 23, 2009

(30) Foreign Application Priority Data
Jun. 25, 2008 (JP) P2008-165852

(51) Int. Cl. H04N 5/91

(52) U.S. Cl. 386/95; 386/131; 386/E05.003

(57) ABSTRACT

A data-processing device includes: a conversion section performing a process of format-conversion in an interactive manner on an AV file between an AV independent format and an AV multiplex format at the time of data communication between an AV server and a network module; a time slot setting section setting a conversion process time slot, a server-side time slot and a network-side time slot; and a time slot control section controlling the allocation of the format conversion process, the data communication process with the AV server and the data communication process with the network module, so that each of the three processes is periodically performed at specified time intervals by allocating the format conversion process and the data communication process on a plurality of AV files to the conversion process time slot and the server-side time slot, respectively, and so that the two processes are performed in parallel.

### BACKGROUND OF THE INVENTION

1. Field of the Invention

The present invention relates to a data-processing device and a data processing method performing AV file format conversion between an audio/video meta independent format and a standard AV (Audio Visual) multiplex format.

2. Description of the Related Art

In recent years, with standardization of communication protocols and the like and a reduction in prices of communication devices and so forth, personal computers equipped with communication interfaces (I/Fs) as standard have become more common. In addition to personal computers, for example, professional-use broadcasting apparatuses such as AV servers and VTRs (Video Tape Recorders) equipped with communication I/Fs as standard or capable of being equipped with communication I/Fs have become more common. A file of video data or audio data (hereinafter video data and audio data are referred to collectively as AV data, if necessary) is exchanged between such broadcasting apparatuses.

In related art, as a format of a file exchanged between broadcasting apparatuses, for example, each model or each manufacturer of broadcasting apparatus generally has its own proprietary format. Therefore, it is difficult to exchange files between broadcasting apparatuses of different models or different manufacturers. Accordingly, as a format for file exchange, for example, the Material Exchange Format (MXF) has been proposed, and is becoming standard. The MXF is a format allowing for not only file exchange but also streaming, and in the MXF, video data and audio data are multiplexed in small units such as frames.

As described above, in the MXF, video data and audio data are multiplexed in frames in consideration of streaming. Therefore, in a broadcasting apparatus, it is difficult to capture an MXF file in a storage and then edit video data and audio data separately from each other (AV independent editing).

Accordingly, there is proposed a method of capturing an MXF file in a broadcasting apparatus and converting the MXF file into a file in a proprietary format. However, when the broadcasting apparatus converts the MXF file into a file in a proprietary format utterly irrelevant to the MXF, and records the file in the storage, it is difficult for other broadcasting apparatuses to use the file. More specifically, for example, in the case where a file in a proprietary format recorded in a storage of a certain broadcasting apparatus is accessed by another broadcasting apparatus through, for example, a communication I/F such as IEEE (Institute of Electrical and Electronics Engineers) 1394 or USB (Universal Serial Bus), when the other broadcast apparatus does not understand the proprietary format, it is difficult for the other broadcasting apparatus to use the file in the proprietary format (for example, to read the file in this case).

Moreover, for example, in the case where a storage where a file in a proprietary format is recorded of a certain broadcasting apparatus is a removable recording medium such as an optical disk, when the removable recording medium is loaded into another broadcasting apparatus, but the other broadcasting apparatus does not understand the proprietary format, it is difficult for the other broadcasting apparatus to use the file in the proprietary format.

Therefore, for example, Japanese Unexamined Patent Application Publication No. 2004-112425 proposes a file format conversion apparatus capable of easily performing editing or the like of a file in which video data, audio data and the like are multiplexed while maintaining compatibility.

### SUMMARY OF THE INVENTION

In Japanese Unexamined Patent Application Publication No. 2004-112425, on an AV server side and on a conversion module side and a network side, a bus has a sufficient bandwidth for bandwidth guarantee, and resources of a CPU (Central Processing Unit) are allocated exclusively to a file format conversion process, thereby performance is improved.

However, in this technique, an increase in a file format conversion process time is a bottleneck, and it is difficult to provide compatibility between bandwidth-guaranteed transmission/reception and best-effort transmission/reception of a plurality of AV files, so there is a room for improvement. For example, when an MXF file is converted, it is necessary to set a parameter (KL Filler) or metadata in a conversion process during transmission/reception, and it is necessary to check the structure of an item in a parsing process during reception. Thereby, there is an issue that access of a CPU to a buffer frequently occurs in a format conversion process.

It is desirable to provide a data-processing device and a data processing method capable of achieving a faster conversion process than ever before while maintaining bandwidth guarantee in the case where file conversion between different formats is performed.

According to an embodiment of the invention, there is provided a data-processing device including: a conversion section performing a process of format-conversion in an interactive manner on an AV file between an AV independent format and an AV multiplex format at the time of data communication between an AV server and a network module, the AV independent format separately containing audio data, video data and metadata, the AV multiplex format containing multiplexed data of the audio data, the video data and the metadata; a time slot setting section setting a conversion process time slot, a server-side time slot and a network-side time slot, the conversion process time slot being used for the format conversion process in the conversion section, the server-side time slot being used for the data communication process with the AV server, the network-side time slot being used for the data communication process with the network module; and a time slot control section controlling the allocation of the format conversion process, the data communication process with the AV server and the data communication process with the network module, so that each of the three processes is periodically performed at specified time intervals by allocating the format conversion process and the data communication process on a plurality of AV files to the conversion process time slot and the server-side time slot, respectively, and so that the two processes are performed in parallel.

According to an embodiment of the invention, there is provided a data processing method including the steps of: performing a process of format-conversion in an interactive manner on an AV file between an AV independent format and an AV multiplex format at the time of data communication between an AV server and a network module, the AV independent format separately containing audio data, video data and metadata, the AV multiplex format containing multiplexed data of the audio data, the video data and the metadata; setting a conversion process time slot, a server-side time slot and a network-side time slot, the conversion process time slot being used for the format conversion process in the previous step, the server-side time slot being used for the data communication process with the AV server, the network-side time slot being used for the data communication process with the network module; and controlling the allocation of the format conversion process, the data communication process with the AV server and the data communication process with the network module, so that each of the three processes is periodically performed at specified time intervals by allocating the format conversion process and the data communication process on a plurality of AV files to the conversion process time slot and the server-side time slot, respectively, and so that the two processes are performed in parallel.

In the data-processing device and the data processing method according to the embodiment of the invention, at the time of data communication between the AV server and the network module, the process of format-conversion is performed in an interactive manner on an AV file between the above-described AV independent format and the above-described AV multiplex format. At this time, the above-described conversion process time slot, the above-described server-side time slot and the above-described network-side time slot are set. Then, the allocation of the format conversion process, the data communication process with the AV server and the data communication process with the network module are controlled, so that each of the three processes is periodically performed at specified time intervals by allocating the format conversion process and the data communication process on a plurality of AV files to the conversion process time slot and the server-side time slot, respectively, and so that the two processes are performed in parallel. Thereby, at the time of data communication between the AV server and the network module, bandwidth guarantee is achieved, and the processes on a plurality of AV files may be performed in parallel.

In the data-processing device or the data processing method according to the embodiment of the invention, the allocation of the format conversion process, the data communication process with the AV server and the data communication process with the network module is controlled, so that each of the three processes is periodically performed at specified time intervals by allocating the format conversion process and the data communication process on a plurality of AV files to the conversion process time slot and the server-side time slot, respectively, and so that the two processes are performed in parallel. Therefore, when file conversion between different formats is performed, the conversion process may be performed faster than ever before while maintaining bandwidth guarantee.

Other and further objects, features and advantages of the invention will appear more fully from the following description.

### BRIEF DESCRIPTION OF THE DRAWINGS

FIG. 1 is a block diagram illustrating a schematic configuration example of an AV network system including a data-processing device according to an embodiment of the invention.

FIG. 2 is an illustration of an example of a standard AV multiplex format.

FIG. 3 is an illustration of an example of an audio/video/meta independent format.

FIG. 4 is a block diagram illustrating a specific configuration example of an independent/multiplex conversion section illustrated in FIG. 1.

FIG. 5 is a block diagram illustrating a specific configuration example of a multiplex/independent conversion section illustrated in FIG. 1.

FIG. 6 is a flowchart illustrating an example of a time slot setting process and a time slot controlling process along a time axis.

FIG. 7 is an illustration of an example of a network module-side time slot used in the processes illustrated in FIG. 6.

FIG. 8 is an illustration of an example of an AV server-side time slot and a conversion section time slot used in the processes illustrated in FIG. 6.

FIG. 9 is an illustration for describing an example of an editing process executed in the AV network system illustrated in FIG. 1.

FIG. 10 is a block diagram for describing an example of the editing process illustrated in FIG. 9.

FIG. 11 is an illustration for describing another example of the editing process executed in the AV network system illustrated in FIG. 1.

FIG. 12 is a block diagram for describing another example of the editing process illustrated in FIG. 11.

FIG. 13 is a block diagram illustrating a configuration example of a computer to which the present invention is applied.

### DETAILED DESCRIPTION OF THE PREFERRED EMBODIMENTS

A preferred embodiment will be described in detail below referring to the accompanying drawings.

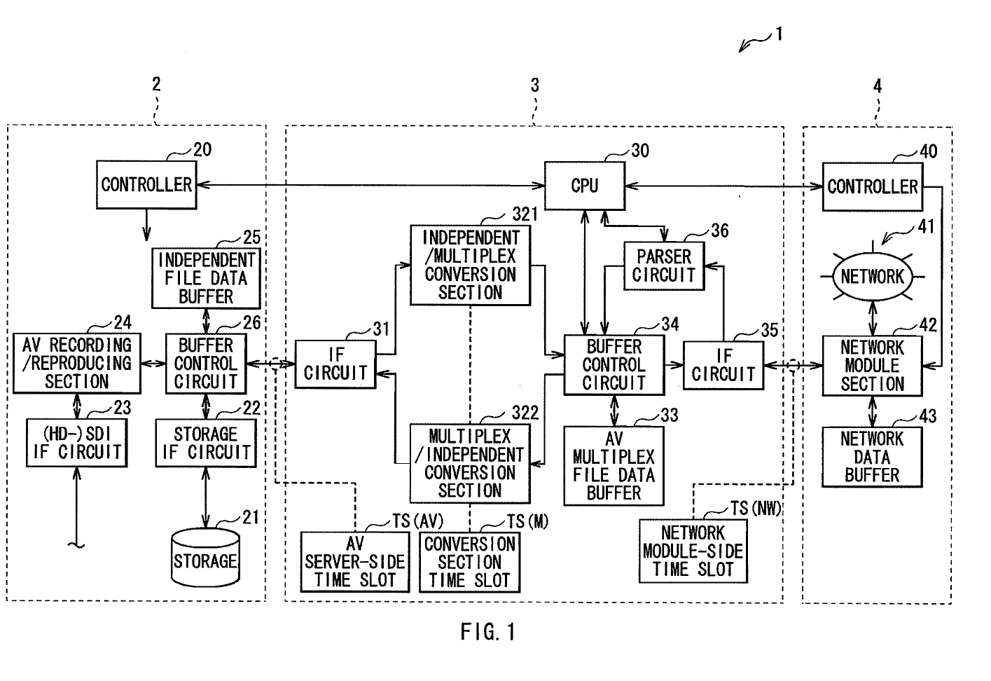

FIG. 1 illustrates a schematic configuration of an AV network system (an AV network system 1) including a data-processing device (a file conversion module 3 which will be described later) according to an embodiment of the invention. The AV network system 1 includes an AV server 2, the file conversion module 3 and a network module 4. The AV server 2 and the file conversion module 3 are connected to each other through a general-purpose bus, and the file conversion module 3 and the network module 4 are connected to each other through a general-purpose bus. In the AV server 2, data of an AV file is stored in an audio/video/meta independent format (hereinafter referred to as AV independent format) which will be described later, and in the network module 4, the data of the AV file is transmitted and received in a standard AV multiplex format which will be described later.

A data processing method according to an embodiment of the invention is embodied by the file conversion module 3 according to the embodiment, so the data processing method will be also described below. Moreover, the term “system” herein is a logical system composed of a plurality of apparatuses, and the apparatuses are not necessarily contained in a single enclosure.

### Configuration of AV Server 2

The AV server 2 includes a controller 20, a storage 21, a storage IF circuit 22, an (HD-)SDIIF (High Definition Serial Digital Interface) circuit 23, an AV recording/reproducing section 24, an independent file data buffer 25 and a buffer control circuit 26. The AV server 2 performs buffer overflow/buffer underflow control on processes by the AV recording/reproducing section 24 and the file conversion module 3 which will be described later.

In a real-time guarantee session which will be described later, when transmission and reception of a data amount calculated from a bandwidth to and from the file conversion module 3 is achieved until a specific time, the AV server 2 controls the real-time guarantee session so as to prevent a real-time failure. Moreover, in a best-effort session which will be described later, buffer information of the AV server 2 is shared with the file conversion module 3, thereby data transfer is performed under the initiative of the file conversion module 3.

The storage 21 temporarily stores data of an AV file in the AV independent format. The storage 21 is configured of a disk-shaped recording medium such as a HDD (Hard Disk Drive) or an optical disk, a tape-shaped recording medium such as magnetic tape, a semiconductor memory, or the like.

The storage IF circuit 22 is an IF circuit arranged between the storage 21 and the buffer control circuit 26 which will be described later.

The (HD-)SDIIF circuit 23 is an IF circuit arranged between the outside of the AV server 2 and the AV recording/reproducing section 24 which will be described later.

The AV recording/reproducing section 24 records and reproduces the data of the AV file in the AV independent format supplied from the (HD-)SDIIF circuit 23 or the buffer control circuit 26 which will be described later, and performs metadata processing such as Timecode.

The independent file data buffer 25 is a buffer temporarily storing the data of the AV file in the AV independent format.

The buffer control circuit 26 is connected to the storage IF circuit 22, the AV recording/reproducing section 24, the independent file data buffer 25 and the file conversion module 3 (more specifically, an IF circuit 31 which will be described later). The buffer control circuit 26 exchanges data of the AV file in the AV independent format with the storage IF circuit 22, the AV recording/reproducing section 24 and the file conversion module 3, and controls the independent file data buffer 25.

The controller 20 controls a process by the whole AV server 2.

### Configuration of File Conversion Module 3

The file conversion module 3 includes a CPU 30, the IF circuit 31, a independent/multiplex conversion section 321, a multiplex/independent conversion section 322, an AV multiplex file data buffer 33, a buffer control circuit 34, an IF circuit 35 and a parser circuit 36.

In the file conversion module 3, a hardware conversion section (in this case, the independent/multiplex conversion section 321 and the multiplex/independent conversion section 322) is provided for each AV file format conversion process. More specifically, in the case of an AV file in the MXF (Material eXchange Format) as the standard AV multiplex format, one conversion module (except for a header and a footer which will be described later) converting each of items which configure the AV file in the MXF as granularity for conversion is provided for each of the items, and the conversion modules are performed in parallel. Moreover, a ring buffer (in this case, the AV multiplex file data buffer 33) for AV files in the standard AV multiplex format in the network module 4 is provided for each session (each AV file processing), and the buffer overflow and buffer underflow of each ring buffer are controlled.

The IF circuit 31 is an IF circuit exchanging data of the AV file in the AV independent format with the buffer control circuit 26 in the AV server 2, and the independent/multiplex conversion section 321 or the multiplex/independent conversion section 322 which will be described later. A bus used in the file conversion module 3 is sufficiently fast.

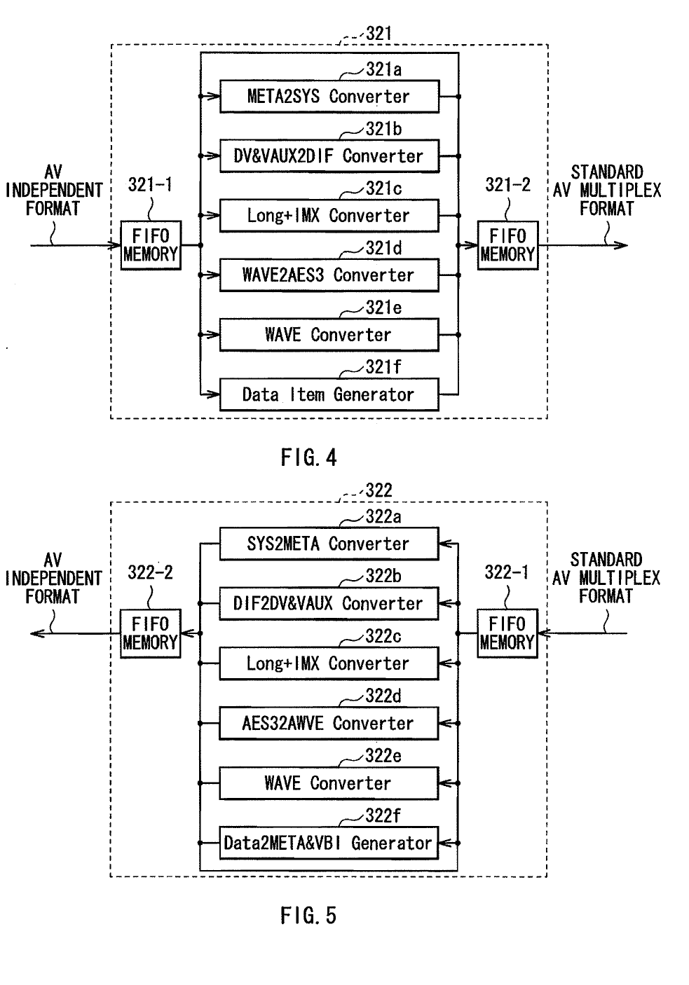

The independent/multiplex conversion section 321 and the multiplex/independent conversion section 322 perform a format conversion process on an AV file between the after-mentioned AV independent format and the after-mentioned AV multiplex format in data transmission/reception between the AV server 2 and the network module 4. More specifically, the independent/multiplex conversion section 321 converts an AV file in the AV independent format supplied from the IF circuit 31 close to the AV server 2 into an AV file in the standard AV multiplex format to supply the AV file in the standard AV multiplex format to the buffer control circuit 34 close to the network module 4. On the other hand, the multiplex/independent conversion section 322 converts an AV file in the standard AV multiplex format supplied from the buffer control circuit 34 close to the network module 4 into an AV file in the AV independent format to supply the AV file in the AV independent format to the IF circuit 31 close to the AV server 2. Specific configurations of the independent/multiplex conversion section 321 and the multiplex/independent conversion section 322 will be described later (refer to FIGS. 4 and 5). Moreover, the independent/multiplex conversion section 321 and the multiplex/independent conversion section 322 correspond to specific examples of “a conversion section” in the invention.

As described above, the AV multiplex file data buffer 33 is configured of, for example, a ring buffer, and is a buffer temporarily storing data of the AV file in the standard AV multiplex format supplied from the network module 4.

The buffer control circuit 34 is connected to the independent/multiplex conversion section 321, the multiplex/independent conversion section 322, the AV multiplex file data buffer 33, the after-mentioned IF circuit 35, the after-mentioned parser circuit 36 and the after-mentioned CPU 30. The buffer control circuit 34 exchanges data of the AV file in the standard AV multiplex format with the independent/multiplex conversion section 321, the multiplex/independent conversion section 322, the IF circuit 35 and the parser circuit 36 in response to control by the CPU 30, and controls the AV multiplex file data buffer 33.

The IF circuit 35 is an IF circuit exchanging data of the AV file in the standard AV multiplex format with the network module 4 (more specifically, a network module section 42 which will be described later), and the after-mentioned parser circuit 36 or the buffer control circuit 34.

The parser circuit 36 captures information necessary for format conversion (information of video data, audio data or metadata which represents details of received data) from received data of the network module 4 in response to control by the CPU 30 to supply the information to the CPU 30, and supplies the received data to the buffer control circuit 34.

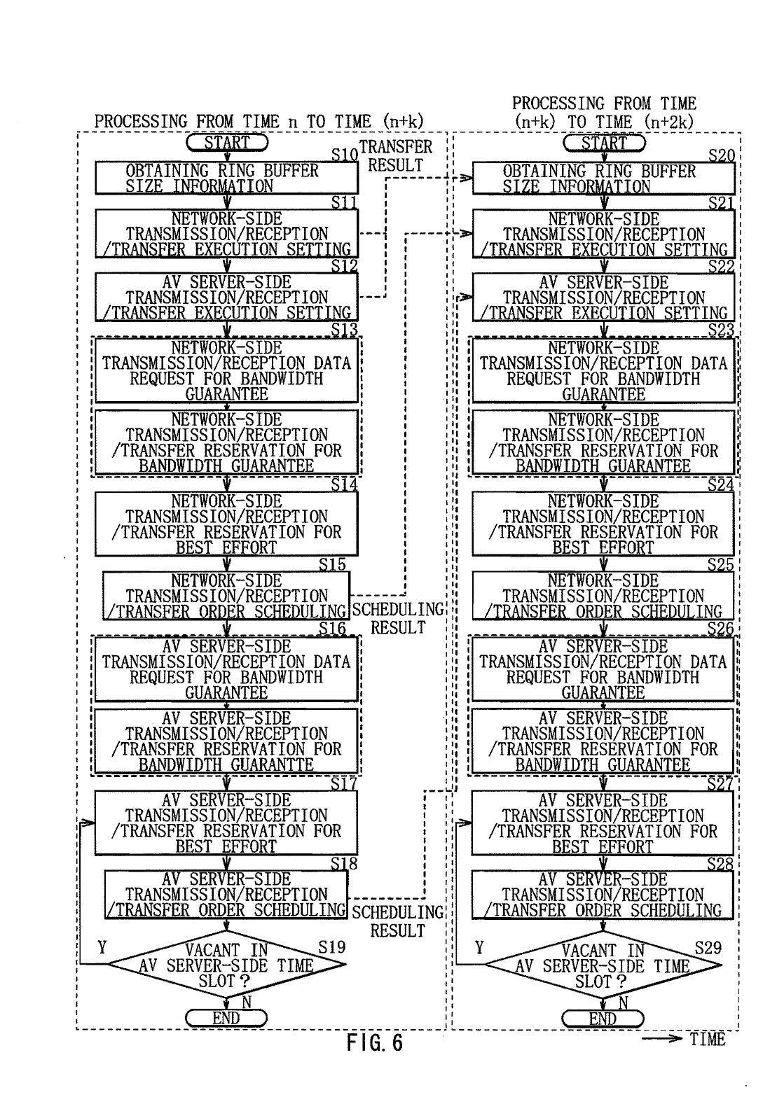

The CPU 30 controls a process by the whole file conversion module 3, and collaborates with the controller 20 in the AV server 2 and a controller 40 in the network module 4 which will be described later. The CPU 30 particularly performs a process (a time slot setting process) of setting each of three time slots which will be described later (that is, a conversion section time slot TS(M), an AV server-side time slot TS(AV) and a network module-side time slot TS(NW)). Moreover, the CPU 30 performs a time schedule process (a time slot controlling process) for the allocation of processes so that synchronous processing is performed at specified time intervals by sequentially allocating a format conversion process or a data transmission/reception process on a plurality of AV files to these time slots, and these processes are performed in parallel. Such a time slot setting process and such a time slot controlling process will be described in detail later (refer to FIGS. 6 to 8).

The CPU 30 and the parser circuit 36 correspond to specific examples of “a time slot setting section” and “a time slot control section” in the invention. Moreover, the CPU 30, the parser circuit 36, the AV multiplex file data buffer 33 and the buffer control circuit 34 correspond to specific examples of “an editing section” in the invention.

As illustrated in FIG. 1, the file conversion module 3 also includes a conversion section time slot TS(M) (a conversion process time slot), an AV server-side time slot TS(AV) (a server-side time slot) and a network module-side time slot TS(NW) (a network-side time slot).

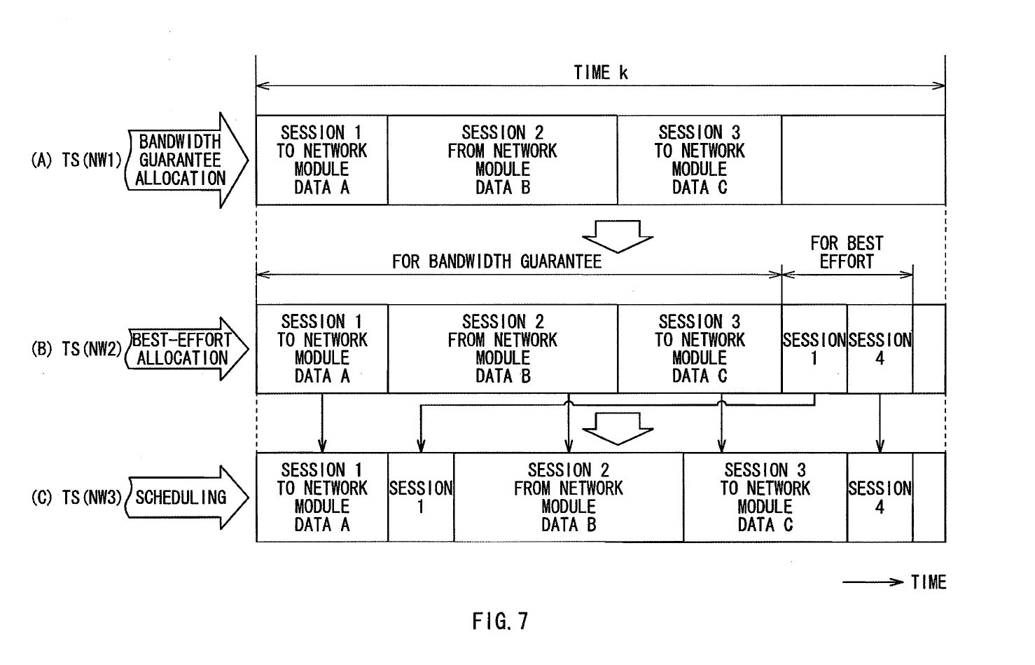

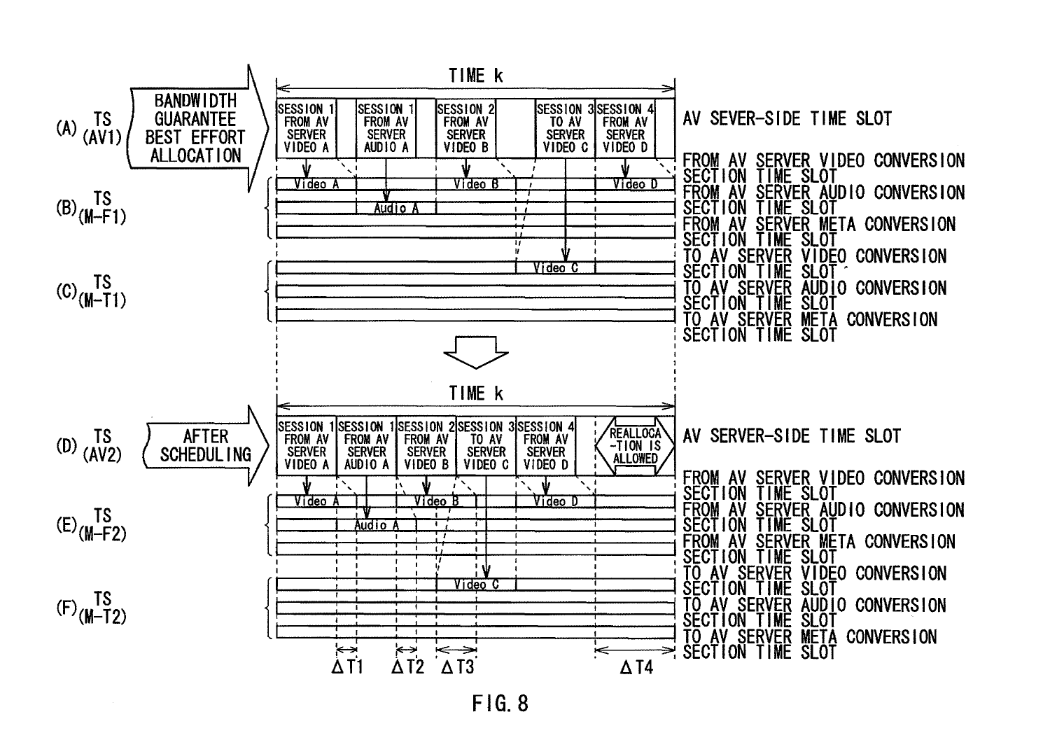

The conversion section time slot TS(M) is a time slot for each format conversion process in the independent/multiplex conversion section 321 and the multiplex/independent conversion section 322. The AV server-side time slot TS(AV) is a time slot for a data transmission/reception process with the AV server 2. The network module-side time slot TS(NW) is a time slot for a data transmission/reception process with the network module 4. These time slots will be described in detail later (refer to FIGS. 7 and 8).

### Configuration of Network Module 4

The network module 4 includes the controller 40, a network 41, a network module section 42 and a network data buffer 43. The network module 4 is a typical Ethernet (trademark) module, and achieves QoS (bandwidth guarantee) control for a plurality of sessions (AV file processing), and performs buffer overflow/buffer underflow control for data of the AV file in the standard AV multiplex format through a buffer (the network data buffer 43) arranged in the network module 4.

In a bandwidth guarantee session which will be described later, when transmission and reception of a data amount calculated from a bandwidth to and from the file conversion module 3 is achieved until a specific time, the network module 4 controls the bandwidth guarantee session so as to prevent a bandwidth guarantee failure. Moreover, in a best-effort session which will be described later, buffer information of the network module 4 is shared with the file conversion module 3, thereby data transfer is performed under the initiative of the file conversion module 3.

The controller 40 controls a process by the whole network module 4. More specifically, the controller 40 specifically controls the network module section 42.

The network module section 42 exchanges data of the AV file in the standard AV multiplex format with the network 41, the network data buffer 43 and the IF circuit 35 in the file conversion module 3 in response to control by the controller 40.

The network data buffer 43 is a buffer temporarily storing data of the AV file in the standard AV multiplex format.

### Configuration Example of Standard AV Multiplex Format

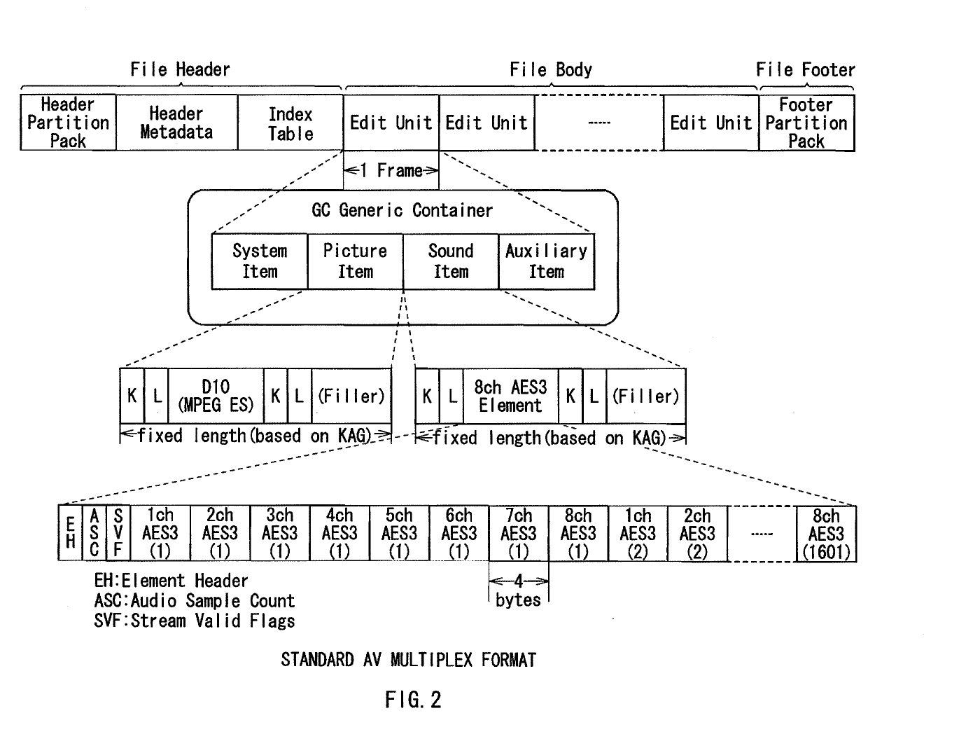

Next, referring to FIG. 2, a configuration example of the standard AV multiplex format will be described below.

FIG. 2 illustrates the standard AV multiplex format which adopts video data coded in accordance with the MPEG (Moving Picture Experts Group) IMX system called D10 as video data contained in a body, and non-compressed audio data in the AES (Audio Engineering Society) 3 format as audio data contained in the body.

In addition, the body may contain video data and audio data in various formats such as DV (Digital Video).

The file in the standard AV multiplex format contains a header (File Header), the body (File Body) and a footer (File Footer) placed in this order from the beginning thereof.

The header contains a header partition pack, header metadata and an index table placed in this order from the beginning thereof. The header partition pack contains data for specifying the header, the form of data contained in the body, information indicating a file format, or the like. The header metadata contains, for example, metadata for individual files such as a file creation data and information about data contained in the body. The index table contains a table indicating the position of an after-mentioned edit unit contained in the body.

In addition, the index table is optional, and may be or may not be included in the header. Moreover, the header may contain various optional data in addition to the index table.

Moreover, as information indicating the file format contained in the header partition pack, in a file in the standard AV multiplex format, information indicating the standard AV multiple format is adopted. On the other hand, in a file in the AV independent format which will be described later, information indicating the AV independent format is adopted. However, the standard AV multiplex format and the AV independent format have a common form of the header partition pack.

The footer contains a footer partition pack. The footer partition pack contains data for specifying the footer and the like.

The body contains one or more edit units. The edit unit is a unit for one frame, and the edit unit contains AV data and the like for one frame.

In other words, the edit unit contains a system item, a picture item, a sound item and an auxiliary item placed in this order from the beginning thereof.

The system item contains metadata (metadata per frame) for a frame of video data contained in the picture item in the following stage. In this case, examples of metadata per frame include Timecode and the like.

The picture item contains video data for one frame. In FIG. 2, video data in the above-described D10 form is contained.

In this case, the picture item contains video data for one frame which is coded to have a KLV (Key, Length, Value) structure.

The KLV structure is a structure in which a key, a length and a value are placed in this order from the beginning thereof. The key contains a 16-byte label according to SMPTE 298M standards which indicates what type of data is contained in the value. The length contains the data length of data contained in the value. The value contains actual data, that is, video data for one frame in this case.

Moreover, the data length of the picture item is a fixed length based on KAG (KLV Alignment Grid). In order for the picture item to have the fixed length, a filler as data for stuffing also has the KLV structure, and is placed subsequent to video data of the picture item.

The fixed length based on KAG as the data length of the picture item is equal to, for example, an integral multiple of the sector length of an optical disk (for example, 512 bytes or 2K bytes). In this case, matching between the optical disk and the picture item becomes higher, thereby a picture item is read and written on the optical disk at higher speed.

Moreover, as in the case of the picture item, the KLV structure is adopted in the above-described system item, and the after-mentioned sound item and the after-mentioned auxiliary item, and the data lengths of these items are fixed lengths based on KAG.

As in the case of the above-described picture item, the sound item contains audio data with the KLV structure for one frame in the frame of the video data contained in the picture item.

Moreover, the sound item contains audio data for a plurality of channels, for example, 8 channels which are multiplexed.

In other words, in the sound item, the value in the KLV structure contains an element header EH, an audio sample count ASC, stream valid flags SVF and audio data for 8 channels which are multiplexed in this order from the beginning thereof.

In this case, in the sound item, the audio data for 8 channels are multiplexed by arranging samples of audio data in order of a first sample, a second sample and subsequent samples of the audio data for each of 8 channels in one frame. In the audio data illustrated in a lowermost part in FIG. 2, numbers in parentheses indicate the ordinal numbers of the samples of the audio data.

Moreover, the element header EH contains data for specifying the element header, and the like. The audio sample count ASC contains the number of samples of audio data contained in the sound item. The stream valid flag SVF is an 8-bit (1-byte) flag, and each bit represents whether or not the audio data for a channel corresponding to the bit is valid. In other words, for example, each bit of the stream valid flag SVF is 1 in the case where the audio data of a channel corresponding to the bit is valid, and, for example, each bit of the stream valid flag SVF is 0 in the case where the audio data is invalid.

The auxiliary item contains necessary user data. Therefore, the auxiliary item is an area where a user is allowed to place arbitrary data.

As described above, in the standard AV multiplex format, the system item containing metadata per frame, the picture item containing video data, the sound item containing audio data and the auxiliary item containing user data are multiplexed frame by frame. Moreover, in the sound item, audio data for 8 channels are multiplexed sample by sample.

Therefore, in the case where video data are collectively contained in a file and audio data are collectively contained in another file, it is difficult to start the reproduction of the video data and the audio data until all of the file collectively containing the video data and the file collectively containing the audio data are received. On the other hand, in the standard AV multiplex format, the video data and the audio data are multiplexed frame by frame, so when video data and audio data for one frame are received, the video data and the audio data for the frame is allowed to be reproduced immediately. Therefore, the standard AV multiplex format is suitable for streaming.

Thus, in the standard AV multiplex format, video data and audio data are multiplexed frame by frame, so the standard AV multiplex format is suitable for streaming. However, it is difficult to perform AV independent editing in which video data and audio data are edited separately.

Moreover, metadata for individual files are scattered throughout the system item of the edit unit, so it is difficult to handle the metadata for individual files during editing or the like.

Further, in the specifications of the AES3 format adaptable in the standard AV multiplex format, at least 4 bytes are allocated to one sample of audio data. Therefore, the whole file has a large size.

### Configuration Example of AV Independent Format

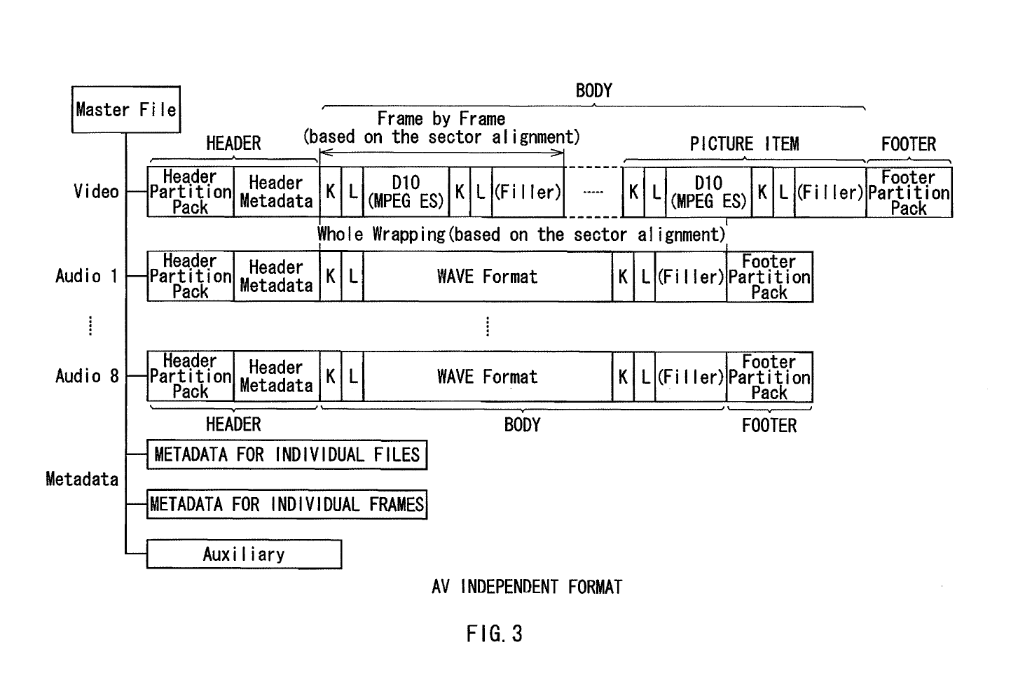

Next, referring to FIG. 3, a configuration example of the AV independent format will be described below.

In the AV independent format, video data, audio data, metadata for individual files and user data which are multiplexed in the above-described standard AV multiplex format are collectively contained in different files, respectively.

In other words, in the AV independent format, picture items containing video data in the standard AV multiplex format are collectively contained in a body, and a header and a footer in the same form as that of the standard AV multiplex format are added to the body to configure a video file.

In the body of the video file in the AV independent format, picture items with a length equal to an integral multiple of the sector length of an optical disk are collectively contained, so the size of the whole body is equal to an integral multiple of the sector length of the optical disk. In other words, the body of the video file in the AV independent format has a size exhibiting sector alignment.

Moreover, in FIG. 2, the index table is illustrated in the header of the file in the standard AV multiplex format. However, in the MXF, as described above, the index table is optional. Therefore, in the video file illustrated in FIG. 3 (also in an audio file which will be described later), the index table is not adopted.

In the AV independent format, multiplexed audio data for 8 channels contained in the sound item in the standard AV multiplex format is separated into audio data for individual channels, and the formats of the audio data for individual channels are converted from the AES3 format to the WAVE format, and the audio data with the KLV structure for individual channels are contained in the bodies of files for individual channels, respectively. A header and a footer in the same format as that of the standard AV multiplex format are added to each of the bodies to configure an audio file.

In other words, in the AV independent format, audio files for 8 channels containing audio data for 8 channels, respectively, are formed independently of one another. In the audio file for each channel, audio data for the channel which is converted into the WAVE format and collectively has the KLV structure is contained in the body. Moreover, a header and a footer in the same format as that of the standard AV multiplex format are added to the body.

In addition, as described above, audio data in the WAVE format for a certain channel collectively having the KLV structure is contained in the body of the audio file in the AV independent format. The size of the whole audio data is not necessarily equal to an integral multiple of the sector length of the optical disk. Therefore, to establish sector alignment, a filler with the KLV structure necessary for establishing sector alignment is placed subsequent to the audio data with the KLV structure in the body of the audio file in the AV independent format.

In addition to the above-described video file and the audio files for 8 channels, the AV independent format contains a metadata file for files collectively containing metadata for individual files which are contained in a header metadata in the standard AV multiplex format, and a metadata file for frames collectively containing system items in which metadata for individual frames are contained in the standard AV multiplex format. Moreover, the AV independent format contains an auxiliary file collectively containing auxiliary items in which user data is contained in the standard AV multiplex format.

Further, the AV independent format contains a master file in which pointers for the video file, the audio files for 8 channels, the metadata file for files, the metadata file for frames and the auxiliary file are written.

In other words, the master file is written in, for example, XML (Extensible Markup Language), and in the master file, for example, the names of these files are written as pointers for the video file, the audio files for 8 channels, the metadata file for files, the metadata for frames and the auxiliary file.

Therefore, the video file, the audio files for 8 channels, the metadata file for files, the metadata file for frames and the auxiliary file are allowed to be referenced from the master file.

In addition, for example, the auxiliary file may be an optional file.

Moreover, in FIG. 3, the metadata file for files and the metadata file for frames and the auxiliary file do not have a header and a footer in the same format as that of the standard AV multiplex format. However, the metadata file for files, the metadata file for frames and the auxiliary file may be configured by adding a header and a footer in the same format as that of the standard AV multiplex format.

Further, in each header metadata configuring each of the headers of the video file and the audio files in the AV independent format, a minimum set of metadata for each of the files is contained.

In other words, in the AV independent format, the metadata file for files collectively containing metadata for individual files which are contained in the header metadata in the standard AV multiplex format is present. Therefore, the metadata for individual files contained in the metadata file are redundantly contained in each of the header metadata configuring each of the headers of the video file and the audio files, thereby to cause an increase in the whole size of the AV independent format.

However, in the MXF, the header metadata is necessary for the header, and when the header is configured without the header metadata, the header is not a header in the same format as that of the standard AV multiplex format.

On the other hand, in the MXF, metadata for each file which is supposed to be contained in the header metadata contains various entries, and some of the entries are necessary, and the others are optional.

Therefore, to prevent an increase in file size, and maintain compatibility with the standard AV multiplex format, only a minimum set of metadata for each file, that is, entries necessary to be contained in the header metadata in the MXF is contained in each of the header metadata configuring each of the headers of the video file and the audio files in the AV independent format.

As described above, in the AV independent format, video data are collectively contained in the video file, and audio data for each channel are collectively contained in the audio file for the channel, so editing such as AV independent editing in which the video data and the audio data are separately edited may be easily performed.

Moreover, in the AV independent format, the audio data is in the WAVE format, so compared to the case where audio data in the AES3 format is adopted as in the case of the standard AV independent format, the data amount may be reduced. As a result, in the case where a file in the AV independent format is recorded in a storage such as an optical disk, the capacity of the storage necessary for recording may be reduced, compared to the case where a file in the standard AV multiplex format is recorded.

Moreover, in the AV independent format, metadata for individual files are collectively contained in one file, and metadata for frames are collectively contained in another file, so a searching process using metadata is easily performed.

### Specific Configuration of Independent/Multiplex Conversion Section 321

Next, referring to FIG. 4, the specific configuration of the independent/multiplex conversion section 321 illustrated in FIG. 1 will be described below. The independent/multiplex conversion section 321 includes FIFO (first-in first-out) memories 321-1 and 321-2 and a META2SYS Converter 321a, a DV&VAUX2DIF Converter 321b, a Long+IMX Converter 321c, a WAVE2AES3 Converter 321d, a WAVE Converter 321e, and a Data Item Generator 321f.

The FIFO memory 321-1 is a memory temporarily storing an AV file in the AV independent format supplied from the IF circuit 31 close to the AV server 2. On the other hand, the FIFO memory 321-2 is a memory temporarily storing an AV file (an AV file in the standard AV multiplex format) of which the format is converted by the ETA2SYS Converter 321a, the DV&VAUX2DIF Converter 321b, the Long+IMX Converter 321c, the WAVE2AES3 Converter 321d, the WAVE Converter 321e and the Data Item Generator 321f all of which will be described later.

The META2SYS Converter 321a performs a process of converting a Universal Label, an LTC, a Body UMID and a KLV Packet (EMK) in a meta-independent format to form a system item in the standard AV multiplex format.

The DV&VAUX2DIF Converter 321b converts a DV-Picture in a Video.mxf and a VAUX Data Item to form DIF Data.

The Long+IMX Converter 321c performs alignment correction on a video independent format (MPEG2 LONG or IMX), if necessary, to form a picture item in the standard AV multiplex format.

The WAVE2AES3 Converter 321d performs format conversion from the WAVE format to the AES3 format.

The WAVE Converter 321e performs a K+L addition process and an alignment process of adding a K, an L and a Filler on a value for each frame.

The Data Item Generator 321f forms a data item from the auxiliary data file and the metadata file.

### Specific Configuration of Multiplex/Independent Conversion Section 322

Next, referring to FIG. 5, the specific configuration of the multiplex/independent conversion section 322 illustrated in FIG. 1 will be described below. The multiplex/independent conversion section 322 includes FIFO memories 322-1 and 322-2, a SYS2META Converter 322a, a DIF2DV&VAUX Converter 322b, a Long+IMX Converter 322c, an AES32WAVE Converter 322d, a WAVE Converter 322e and a Data2META&VBI Generator 322f.

The FIFO memory 322-1 is a memory temporarily storing an AV file in the AV multiplex format supplied from the buffer control circuit 34 close to the network module 4. On the other hand, the FIFO memory 322-2 is a memory temporarily storing an AV file (an AV file in the AV file independent format) of which the format is converted by the SYS2META Converter 322a, the DIF2DV&VAUX Converter 322b, the Long+IMX Converter 322c, the AES32WAVE Converter 322d, the WAVE Converter 322e and the Data2META&VBI Generator 322f all of which will be described later.

The SYS2META Converter 322a forms a meta-independent format from a system item in the standard AV multiplex format by a process of adding an LTC/UB, a Body UMID, a KLV Packet(EMK) and an ARIB.

The DIF2DV&VAUX Converter 322b forms a DV-Picture, and performs an alignment addition process to form a VAUX Data Item.

The Long+IMX Converter 322c performs alignment correction on picture items (MPEG2 LONG and IMX) in the standard AV multiplex format, if necessary, to form video independent formats.

The AES32WAVE Converter 322d performs a format conversion process from the AES3 format to the WAVE format.

The WAVE Converter 322e extracts only audio sample data to form an audio independent format.

The Data2META&VBI Generator 322f forms a meta-independent format from a data item in the standard AV multiplex format.

Next, operation of the AV network system 1 according to the embodiment will be described in detail below.

### Basic Operation of AV Network System 1

First, referring to FIG. 1, basic operation of the AV network system 1 will be described below. In the AV network system 1, a data transmission/reception process on an AV file is performed each between the AV server 2 and the file conversion module 3 and between the network module 4 and the file conversion module 3. Moreover, in the data transmission/reception process, AV file format conversion between the AV independent format and the standard AV multiplex format is performed in the file conversion module 3.

More specifically, in the AV server 2, when data of an AV file in the AV independent format read out from the storage 21 or outside through the (HD-)SDIIF circuit 23 is transmitted to the file conversion module 3, the format of the data of the AV file is converted in the independent/multiplex conversion section 321 in the file conversion module 3 to form data of the AV file in the standard AV multiplex format. Then, the data of the AV file in the standard AV multiplex format is transmitted to the network module 4.

Further, in the network module 4, when the data of the AV file in the standard AV multiplex format supplied from the network 41 is transmitted to the file conversion module 3, the format of the data of the AV file is converted by the multiplex/independent conversion section 322 in the file conversion module 3 to form data of the AV file in the AV independent format. Then, the data of the AV file in the AV independent format is transmitted to the AV server 2 to be recorded in the storage 21 or to be reproduced by the AV recording/reproducing section 24.

### Operation of File Conversion Module 3

Next, referring to FIGS. 6 to 8, operation in a format conversion process (the above-described time slot setting process and the above-described time slot controlling process) by the file conversion module 3 which is one characteristic part of the invention will be described in detail below.

FIG. 6 illustrates a flowchart along a time axis of an example of the time slot setting process and the time slot controlling process in the format conversion process by the independent/multiplex conversion section 321 and the multiplex/independent conversion section 322, and FIG. 6 illustrates processing from an arbitrary time n and another arbitrary time (n+k) and processing from the time (n+k) to a still another arbitrary time (n+2k). The time k represents a duration necessary for processes from steps S10 to S19 or processes from steps S20 to S29 which will be described later. Moreover, FIGS. 7(A), 7(B) and 7(C) illustrate network module-side time slots TS(NW1), TS(NW2) and TS(NW3), respectively, in the processes illustrated in FIG. 6. FIGS. 8(A) to 8(F) illustrate conversion section time slots TS(M-F1), TS(M-T1), TS(M-F2) and TS(M-T2) and AV server-side time slots TS(AV1) and TS(AV2), respectively, in the processes illustrated in FIG. 6. The conversion section time slots TS(M-F1) and TS(M-F2) indicate time slots when converting the format of data of an AV file in the AV independent format received from the AV server 2, and the conversion section time slots TS(M-T1) and TS(M-T2) indicate time slots when converting the format of data of an AV file in the standard AV multiplex format received from the network module 4. Moreover, each of these time slots includes time slots of video data, audio data and metadata, and these time slots are time slots in conversion modules in FIGS. 4 and 5.

In the file conversion module 3 according to the embodiment, for example, the time slot setting process and the time slot controlling process illustrated in FIG. 6 are performed by the CPU 30 and the parser circuit 36. In addition, processing illustrated in the drawing from the arbitrary time n to another arbitrary time (n+k) (steps S10 to S19) is the same as processing from the time (n+k) to the time (n+2k) (steps S20 to S29), so only the steps S20 to S29 will be described below.

### Obtaining Ring Buffer Size Information

First, on the basis of data transfer results in the step S11 (network-side transmission/reception/transfer execution setting) and the step S12 (AV server-side transmission/reception/transfer execution setting) in the previous processing and a result of item structure confirmation by the parser circuit 36, information necessary for format conversion (in this case, ring buffer size information) is obtained (step S20).

### Network-Side Transmission/Reception/Transfer Execution Setting

Next, on the basis of a result by scheduling in the step S15 (network-side transmission/reception/transfer order scheduling) in the previous processing, a plurality of sessions of data transmission/reception/transfer of the AV file are executed by the CPU 30 (step S21).

### AV Server-Side Transmission/Reception/Transfer Execution Setting

Next, on the basis of a result by scheduling in the step S18 (AV server-side transmission/reception/transfer order scheduling) in the previous processing, a plurality of sessions of data transmission/reception/transfer of the AV file are executed by the CPU 30 between the file conversion module 3 and the AV server 2 (step S22). At this time, on the basis of the result by the scheduling, the independent/multiplex conversion section 321 and the multiplex/independent conversion section 322 execute a plurality of sessions of the format conversion process on the AV file at the time of data transmission/reception with the AV server 2.

### Network-Side Transmission/Reception Data Request/Transfer Reservation for Bandwidth Guarantee

Next, on the reception of a plurality of sessions of transmission/reception data requests for bandwidth guarantee from the network module 4, for example, as illustrated in FIG. 7(A), the CPU 30 reserves transfer timings to the network module side time slot TS(NW1) (step S23). Thereby, a failure in bandwidth control in the network module 4 side is prevented.

### Network-Side Transmission/Reception/Transfer Reservation for Best Effort

Next, in the case where a vacant slot is present in the network module-side time slot TS(NW1), as in the case of the network module-side time slot TS(NW2) illustrated in FIG. 7(B), for example, the CPU 30 allocates a data transfer process for best effort to the vacant slot according to priority on a session which corresponds to a ring buffer being most likely to be overflowed or underflowed (step S24).

### Network-Side Transmission/Reception/Transfer Order Scheduling

Next, for example, as in the case of the network module-side time slot TS(NW3) illustrated in FIG. 7(C), by the CPU 30, reservation timings determined in the steps S23 and S24 are aligned so that the reservation timings for the same sessions are bound together (step S25).

### AV Server-Side Transmission/Reception Data Request/Transfer Reservation for Bandwidth Guarantee

Next, on the reception of a plurality of sessions of transmission/reception data requests for bandwidth guarantee from the AV server 2, the CPU 30 reserves transfer timings in the AV server-side time slot TS(AV) and the conversion section time slot TS(M) (step S26). Thereby, a failure in real-time processing (recording and reproducing system) in the AV server 2 side is prevented.

### AV Server-Side Transmission/Reception/Transfer Reservation for Best Effort

Next, in the case where a vacant slot is present in the AV server-side time slot TS(AV), for example, as illustrated in the AV server-side time slot TS(AV1) in FIG. 8(A), the CPU 30 allocates a data transfer process for best effort to the vacant slot according to priority on a session which corresponds to a ring buffer being most likely to be overflowed or underflowed (step S27). Moreover, at this time, for example, as illustrated in the conversion section time slots TS(M-F1) and TS(M-T1) in FIGS. 8(B) and 8(C), data transfer for best effort is allocated to a time slot in each conversion module in the same manner, but it is necessary to add a time necessary for format conversion. Thereby, a bandwidth which is not used for data transfer with the AV server 2 is effectively used.

### AV Server-Side Transmission/Reception/Transfer Order Scheduling

Next, for example, as illustrated in the AV server-side time slot TS(AV2) and the conversion section time slots TS(M-F2) and TS(M-T2) in FIGS. 8(D) to 8(F), the CPU 30 control scheduling for the allocation of processes so as to be performed in parallel at the reserved timings determined in the steps S23 and S24 (refer to parallel processing periods ΔT1 to ΔT3 in the drawing) (step S28). Thereby, scheduling is made so as to make full use of parallel processing by hardware, and it is useful for best effort transfer. In addition, as illustrated in the AV server-side time slot TS(AV2) in the drawing, as long as a vacant slot is present in the AV server-side time slot TS(AV) (step S29), the processes in the steps S27 and S28 are repeated, and then the processes in the steps S20 to S29 are completed.

Thus, in the embodiment, at the time of data transmission/reception between the AV server 2 and the network module 4, the format conversion process on an AV file is performed between the AV independent format and the AV multiplex format in an interactive manner. At this time, the conversion section time slot TS(M), the AV server-side time slot TS(AV) and the network module-side time slot TS(NW) are set. Then, the allocation of the processes is controlled so that synchronous processing is performed at specified time intervals by sequentially allocating the format conversion process or the data transmission/reception process on a plurality of AV files to the conversion section time slot TS(M) and the AV server-side time slot TS(AV), and the processes are performed in parallel. Thereby, at the time of data transmission/reception between the AV server 2 and the network module 4, the bandwidth guarantee is achieved, and the processes on a plurality of AV files are allowed to be performed in parallel.

As described above, in the embodiment, the allocation of the processes is controlled so that synchronous processing is performed at specified time intervals by sequentially allocating the format conversion process or the data transmission/reception process on a plurality of AV files to the conversion section time slot TS(M) and the AV server-side time slot TS(AV), and the processes are performed in parallel. Thereby, bandwidth guarantee is achieved, and the processes on a plurality of AV files are allowed to be performed in parallel. Therefore, when file conversion between different formats is performed, the conversion process may be performed faster than ever before while maintaining the bandwidth guarantee.

Moreover, in the AV server 2, data of an AV file in the AV independent format read out from the storage 21 or outside through the (HD-)SDIIF circuit 23 is transmitted to the file conversion module 3, and the format of the data of the AV file is converted in the independent/multiplex conversion section 321 in the file conversion module 3 to produce data of an AV file in the standard AV multiplex format, and bandwidth-guarantee transmission and best-effort network transmission to the network module 4 are performed on the data of the AV file in the standard Av multiplex format.

Further, in the network module 4, bandwidth-guarantee reception and best-effort network reception of the data of the AV file in the standard AV multiplex format supplied from the network 41 are performed in the file conversion module 3, and the format of the data of the AV file is converted in the multiplex/independent conversion section 322 in the file conversion module 3 to produce data of the AV file in the AV independent format, and the data of the AV file in the AV independent format is transmitted to the AV server 2 to be recorded in the storage 21 or be reproduced by the AV recording/reproducing section 24.

### Application Example in Editing Process

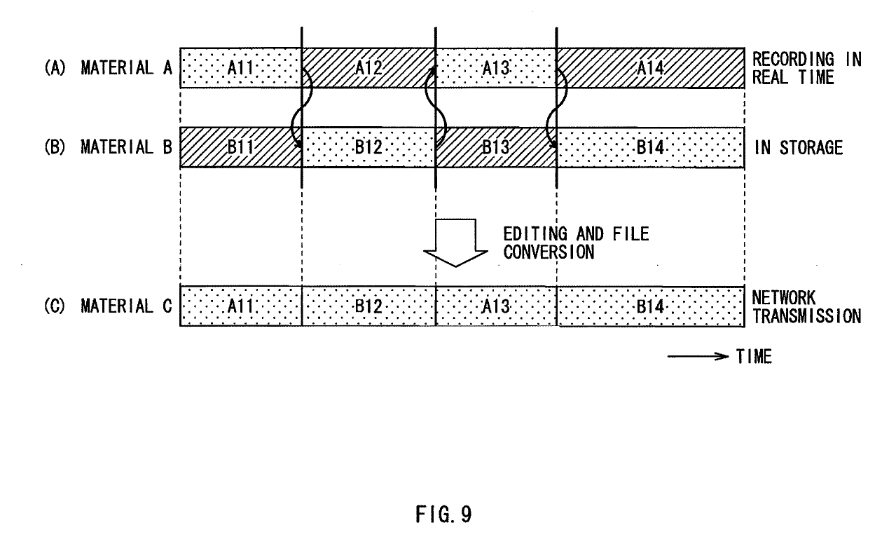

The AV network system 1 described in the above-described embodiment is applicable, for example, in an editing process illustrated in FIGS. 9 to 12. More specifically, through the use of an EDL (Edit Decision List), an editing process on an AV file may be performed while performing a conversion process on the AV file.

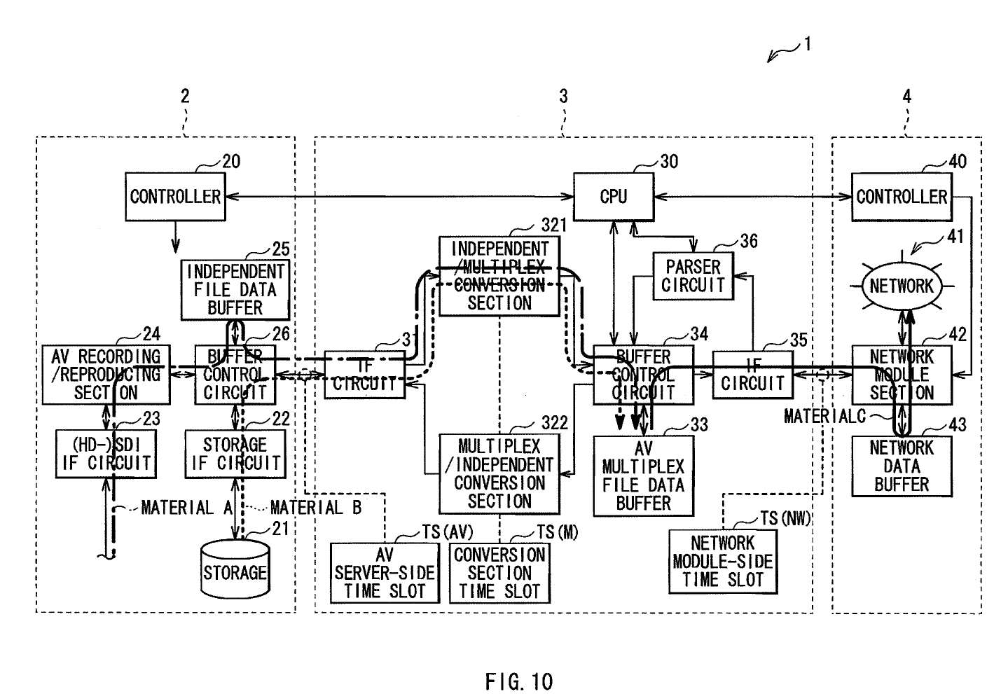

More specifically, for example, as illustrated in FIGS. 9(A) to 9(C) and FIG. 10, while an editing process in which a material A (a mixture of audio/video/meta independent formats or any one of them in the AV independent format) stored in the AV recording/reproducing section 24 and a material B (a mixture of audio/video/meta independent formats or any one of them in the AV independent format) stored in the storage 21 are edited to form one material (a material C) based on the EDL, and a format conversion process on the materials A and B are executed, bandwidth-guarantee network transmission may be achieved.

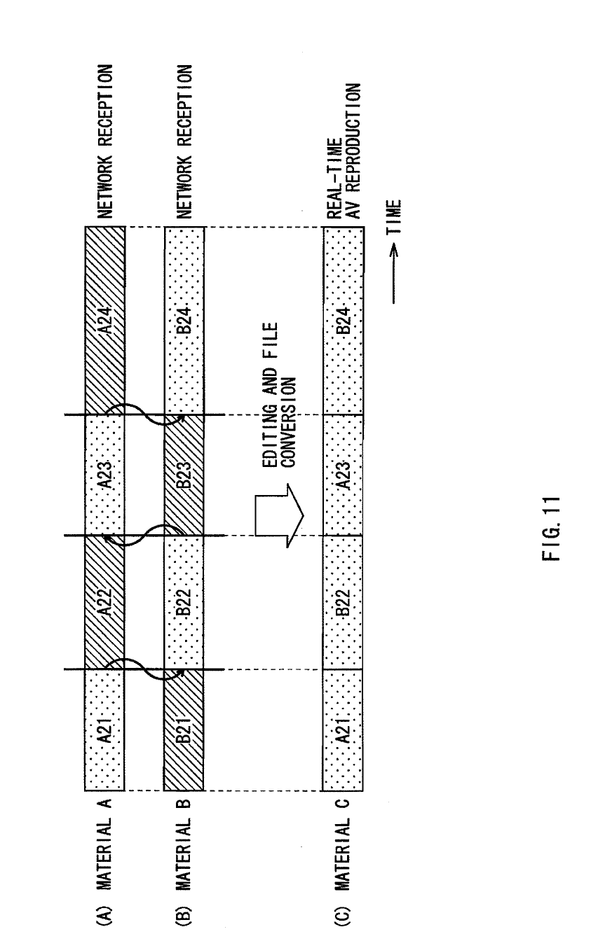

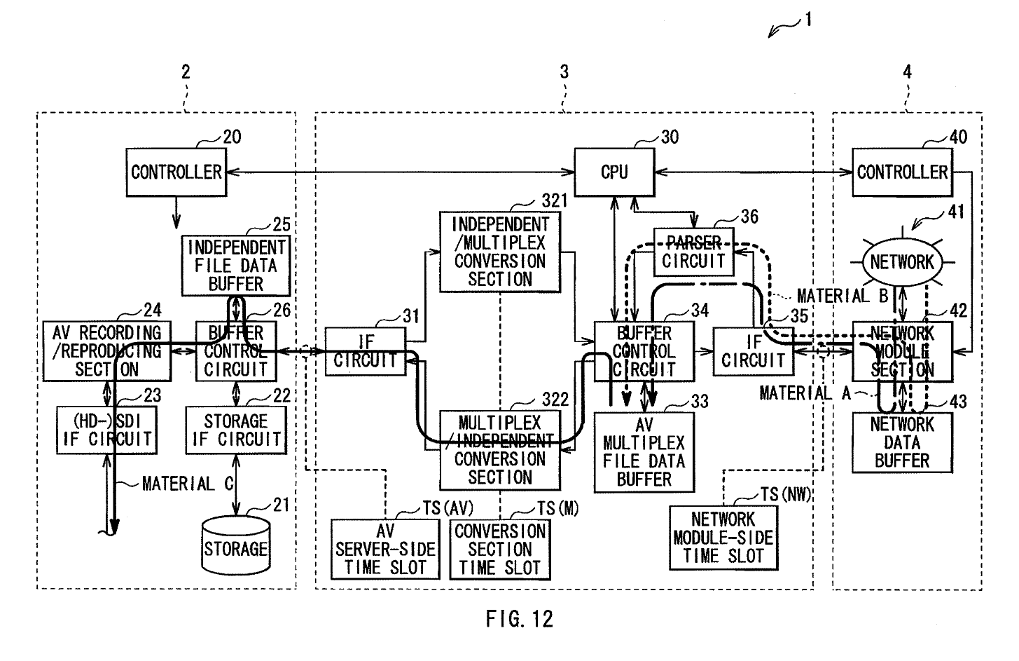

Moreover, for example, as illustrated in FIGS. 11(A) to 11(C) and FIG. 12, while an editing process in which two materials A and B received by bandwidth-guarantee network reception are edited to form one material (the material C) based on the EDL, and a format conversion process on the materials A and B are executed, real-time AV reproduction may be achieved.

Thus, through the use of the EDL, without executing the EDL on a local server, an executed file may be transferred to other users.

Although the present invention is described referring to the embodiment and the application examples, the invention is not limited thereto, and may be variously modified.

For example, a combination of processes in the steps S21 to S28 is changed depending on a used application to be used. More specifically, for example, any one of a combination of the processes in steps S22, S27 and S28, a combination of the processes in the steps S22 and S26, a combination of the processes in the steps S22 and S26 to S28, a combination of the processes in the steps S21, S24 and S25, a combination of the processes in the steps S21 and S23 and a combination of the processes in the steps S21 and S23 to S25 is used depending on an used application.

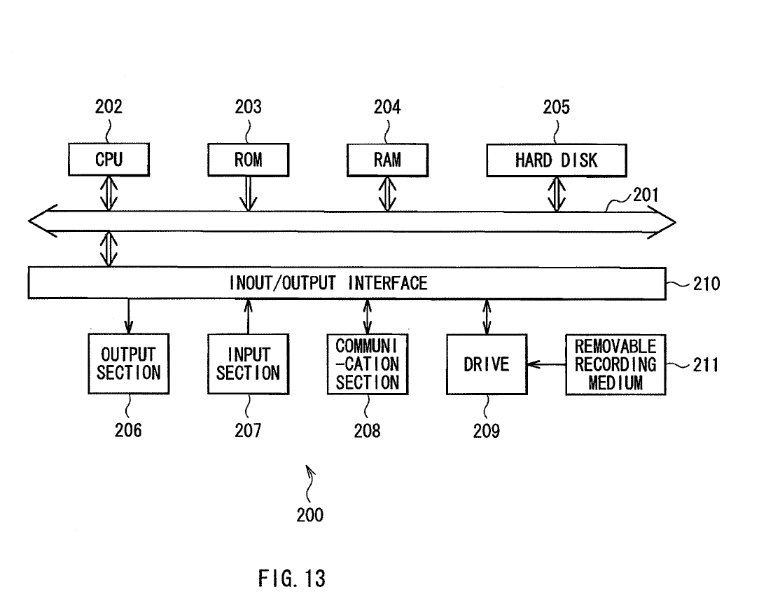

Moreover, the processes described in the above-described embodiment and the like may be performed by hardware or software. In the case where the processes are performed by software, a program configuring the software is installed in a general-purpose computer or the like. FIG. 13 illustrates a configuration example of an embodiment of a computer where a program executing the processes is installed. Such a program may be previously stored in a hard disk 205 or a ROM 203 as a recording medium included in the computer 200. Alternatively, the program may be stored (recorded) temporarily or permanently in a removable recording medium 211 such as a flexible disk, a CD-ROM (Compact Disc Read Only Memory), an MO (Magneto Optical) disk, a DVD (Digital Versatile Disc), a magnetic disk or a semiconductor memory. Such a removable recording medium 211 may be provided as so-called package software. In addition to installing the program into the computer from the above-described removable recording medium 211, the program is transferred to the computer from a download site through a satellite for digital satellite broadcasts without wires, or through a network such as LAN (Local Area Network) or the Internet with wires, and then in the computer, the program transferred in such a manner is received in a communication section 208 to be installed in a built-in hard disk 205.

Moreover, the computer 200 includes a CPU 202. An input/output interface 210 is connected to the CPU 202 through a bus 201. When a user inputs a command by operating an input section 207 such as a keyboard, a mouse or a microphone, the CPU 202 executes a program stored in a ROM (Read Only Memory) 203 accordingly. Alternatively, the CPU 202 loads a program stored in the hard disk 205, a program transferred through a satellite or a network to be received by the communication section 208 and then installed in a hard disk 205, or a program read out from a removable recording medium 211 placed in a drive 209 to be installed in the hard disk 205 into a RAM (Random Access Memory) 204, and then executes the program. Thereby, the CPU 202 performs processes according to the above-described flowchart or processes executed according to the configuration illustrated in the above-described block diagram. Then, for example, if necessary, the CPU 202 outputs a result by the processes to an output section 206 such as an LCD (Liquid Crystal Display) or a speaker through the input/output interface 210, or transmits the result from the communication section 208 and then stores the result in the hard disk 205.

In this case, in the description, process steps describing a program for allowing the computer to perform various processes are not necessarily performed in a time sequential manner in the order described in the flowchart, and the process steps include processes which are executed in parallel or independently (for example, parallel processing or processing by an object). Moreover, the program may be processed by one computer or may be distributed and processed by a plurality of computers. Further, the program may be transferred to a remote computer to be executed.

Moreover, in the above-described embodiment and the like, as the file in the standard AV multiplex format, an MXF-compliant file is used. However, any other file may be used as the file in the standard AV multiplex format. More specifically, in addition to the MXF-compliant file, a file in which a header, a body and a footer are contained, and multiplexed data of two or more arbitrary data is contained in the body may be used.

Further, in the above-described embodiment and the like, in the body of the file in the standard AV multiplex format, multiplexed data of video data and audio data is placed. However, in the body of the file in the standard AV multiplex format, multiplex data of two or more video data (streams of two or more video data) or multiplexed data of two or more audio data (streams of two or more audio data) may be placed.

The present application contains subject matter related to that disclosed in Japanese Priority Patent Application JP 2008-165852 filed in the Japanese Patent Office on Jun. 25, 2008, the entire content of which are hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. A data-processing device comprising:
a conversion section performing a process of format-conversion in an interactive manner on an AV file between an AV independent format and an AV multiplex format at the time of data communication between an AV server and a network module, the AV independent format separately containing audio data, video data and metadata, the AV multiplex format containing multiplexed data of the audio data, the video data and the metadata;
a time slot setting section setting a conversion process time slot, a server-side time slot and a network-side time slot, the conversion process time slot being used for the format conversion process in the conversion section, the server-side time slot being used for the data communication process with the AV server, the network-side time slot being used for the data communication process with the network module; and
a time slot control section controlling the allocation of the format conversion process, the data communication process with the AV server and the data communication process with the network module, so that each of the three processes is periodically performed at specified time intervals by allocating the format conversion process and the data communication process on a plurality of AV files to the conversion process time slot and the server-side time slot, respectively, and so that the two processes are performed in parallel.

2. The data-processing device according to claim 1, wherein
the time slot control section allocates a best-effort data communication process with the AV server to a vacant server-side time slot, and allocates the format conversion process on the AV files which are subjected to the two data communication processes to a vacant conversion process time slot, and then controls scheduling for the allocation of the processes so as to be performed in parallel.

3. The data-processing device according to claim 2, wherein
the time slot control section allocates a bandwidth-guarantee data communication process with the AV server to the server-side time slot, and then allocates a best effort data communication process with the AV server to the server-side time slot.

4. The data-processing device according to claim 2, wherein
as long as a vacant server-side time slot is present, the time slot control section allocates a best effort data communication process to the vacant server-side time slot.

5. The data-processing device according to claim 2, wherein
the conversion section, at the time of performing the data communication with the AV server, executes the format conversion process on a plurality of AV files, on the basis of a result of scheduling control performed by the time slot control section just before the format conversion process.

6. The data-processing device according to claim 1, further comprising:
an editing section performing an editing process on the AV files through the use of an EDL (Edit Decision List),
wherein the editing process on the AV files is performed by the editing section while performing format conversion on the AV files by the conversion section.

7. The data-processing device according to claim 1, wherein
the AV multiplex format is a MXF (Material eXchange Format).

8. A data processing method comprising the steps of:
performing a process of format-conversion in an interactive manner on an AV file between an AV independent format and an AV multiplex format at the time of data communication between an AV server and a network module, the AV independent format separately containing audio data, video data and metadata, the AV multiplex format containing multiplexed data of the audio data, the video data and the metadata;
setting a conversion process time slot, a server-side time slot and a network-side time slot, the conversion process time slot being used for the format conversion process in the previous step, the server-side time slot being used for the data communication process with the AV server, the network-side time slot being used for the data communication process with the network module; and
controlling the allocation of the format conversion process, the data communication process with the AV server and the data communication process with the network module, so that each of the three processes is periodically performed at specified time intervals by allocating the format conversion process and the data communication process on a plurality of AV files to the conversion process time slot and the server-side time slot, respectively, and so that the two processes are performed in parallel.
